(19) United States
(12) Patent Application Publication
(10) Pub. No.: US 2019/0032751 A1
(43) Pub. Date: Jan. 31, 2019

(54) CLAMPING ARRANGEMENT FOR CLAMPING A FLEXIBLE LINE

(71) Applicant: Anthony Garlick, Old Glossop (GB)

(72) Inventor: Anthony Garlick, Old Glossop (GB)

(21) Appl. No.: 16/071,508

(22) PCT Filed: Jan. 23, 2017
(86) PCT No.: PCT/GB2017/050157

§ 371 Date: Jul. 20, 2018

(30) Foreign Application Priority Data
Jan. 22, 2016 (GB) 1601203.1

(51) Int. Cl. F16G 11/10; A01K 1/10

(52) U.S. Cl. CPC F16G 11/10; A01K 1/10

(57) ABSTRACT

The present invention relates to a clamping arrangement for clamping a flexible line, and which may be used for carrying an object from a support structure at an above ground level. According to the present invention there is a clamping arrangement for clamping a flexible line the clamping arrangement comprising a body structure arranged to be mounted to a support structure and having an upper end and a longitudinally spaced lower end and comprising an opening therein, the opening having a longitudinal length extending between an upper end and a lower end. The invention further comprises a clamping element arranged to cooperate with the body structure and extend across the opening, wherein an upper separation gap is defined between the upper end of the opening and the clamping element and a lower separation gap is defined between the lower end of the opening and the clamping element, the upper and lower separation gaps configured to allow a flexible line to extend through the upper and lower separation gaps concurrently, wherein the clamping element is moveable longitudinally relative to the body structure such that tensioning a flexible line passed through the lower and upper separation gaps and projecting from the upper separation gap forces the clamping element downwardly to clamp the flexible line between the clamping element and the body structure.

The present invention relates to a clamping arrangement for clamping a flexible line, and which may be used for carrying an object from a support structure at an above ground level. The support structure is typically the wall or ceiling of a building and the object may, for example, be a hay net which is provided to hold a quantity of hay as a feed for animals such as horses or donkeys.

A hay net is a net shaped to hold a quantity of hay with a cord retained adjacent the edge of the opening in the net. The use of hay nets is a preferred method of feeding a horse or donkey in particular as the size of the mesh can be varied dependent upon requirements for the particular animal. For example, the size of the mesh can be limited to reduce the speed the animal eats and may be changed dependent upon the type of feed used. Hay nets are also beneficial in that the feed is hung above the floor so it cannot be walked on or mixed with bedding or droppings. The cord is typically passed through the openings of the net such that as the cord is lifted off the ground by grasping the opposing ends of the cord the opening of the net is effectively drawn closed by this action. The openings in the net are sufficiently large for an animal to draw hay from the net but sufficiently small so that hay does not continuously fall from the net and onto the floor.

Once the hay net cord is pulled tight the opening is closed and the ends of the cord are passed through a wall ring which is secured to a stable wall. Once it is pulled through the ring, the cord is pulled such that the hay net is raised above the ground and the cord is then tied, typically around the bottom of the net to secure the net in position. The net once filled with hay (depending on the size of the animal) can be relatively large and weigh around 10-15 kgs meaning that this task may be difficult.

There are a number of problems associated with the use of hay nets. A first problem is that the animal can pull the cord which may open the net and allow it to fall to the ground where the feed content will get mixed with bedding and droppings. A further problem is that the cord may be pulled so tight that the only way to remove it for replenishing with feed is to cut it down thus reducing the cord length. A further problem is that it is difficult to lift a heavy hay net whilst simultaneously feeding the ends of the cord through a wall ring and then tie off the cord without accidentally dropping the hay net.

The present invention provides an improved arrangement.

According to the present invention there is a clamping arrangement for clamping a flexible line the clamping arrangement comprising:
a body structure arranged to be mounted to a support structure and having an upper end and a longitudinally spaced lower end and comprising an opening therein, the opening having a longitudinal length extending between an upper end and a lower end;
a clamping element arranged to cooperate with the body structure and extend across the opening, wherein an upper separation gap is defined between the upper end of the opening and the clamping element and a lower separation gap is defined between the lower end of the opening and the clamping element, the upper and lower separation gaps configured to allow a flexible line to extend through the upper and lower separation gaps concurrently, wherein the clamping element is moveable longitudinally relative to the body structure such that tensioning a flexible line passed through the lower and upper separation gaps and projecting from the upper separation gap forces the clamping element downwardly to clamp the flexible line between the clamping element and the body structure.

The present invention removes the difficulties faced with securing an object such as a hay net above the ground and also allows ease of replenishment of the object, for example a hay net, as necessary. The flexible line in a form of a cord or rope for example may be provided as a continuous loop or having open ends. The ends extending from the object are passed through the upper and then lower separation gaps respectively and the support arrangement is then ready for use. For increased security a knot may be tied in the open ends once passed through the lower separation gap or a knot may be tied in the loop portion as appropriate. The clamping arrangement can then be grasped and lifted and the object accordingly also lifted, where the action of the weight of the object upon the flexible line causes the downward movement of the clamping element effectively reducing the lower separation gap thus clamping the flexible line between the clamping element and the body structure. For replenishment of the hay net when the tension is removed from the flexible line, the clamping element is moveable upwardly thus releasing the clamping force on the flexible line meaning that the clamping arrangement can be slid up and down the flexible line as necessary in order to provide enough slack in the flexible line to open up the hay net for replenishment.

The clamping arrangement may be termed a support arrangement for supporting a load or carrying an object at an above-ground level.

The flexible line may be tensioned by hanging an object therefrom.

The clamping element is beneficially slideably engaged with the body arrangement. Thus the clamping element is preferably slideable up and down in the longitudinal axis.

It will further be appreciated that as the clamping element is movable and preferably slideable longitudinally relative to the body structure the longitudinal length of the upper and lower separation gaps accordingly change. Thus, the upper separation gap increases as the clamping element moves downwardly and the longitudinal length of the lower separation gap reduces.

It will be appreciated that the clamping arrangement has been designed for clamping a tensioned line, and for one application in supporting a hay net from a flexible line.

It will further be appreciated that the clamping element is designed to fix or jam the flexible line between the clamping element and the body structure at the edge of the opening. The clamping element is preferably captive in the body structure. The clamping element is beneficially retained in the body structure. It is beneficial that the body structure can be grasped by a user without impacting upon the clamping element without requiring direct contact with the clamping element.

The body structure preferably defines a chamber therein for receipt of the clamping element.

The body structure preferably comprises opposing channels and wherein the clamping element preferably comprises opposing edge portions received in the opposing respective channels. The clamping element therefore slides along the opposing channels and is retained by these channels.

The body structure is beneficially handheld. The longitudinal length of the body structure is beneficially less than 20 cm, and preferably less than 10 cm. It will however be appreciated that the clamping arrangement may be utilised for other applications where it is necessary to have a tensioned line such as for example securing loads in a vehicle or locking down equipment on a boat, or used on seatbelts or lap belts in order to adjust the length of the strap for comfort in use.

The body structure preferably comprises a mounting structure for releasably mounting to a support structure preferably at the upper end of the body structure. The mounting structure may take a variety of forms. In one embodiment the mounting structure may comprise a male/female engaging part for attachment to an opposing male/female engaging part. The male/female part may be moveably mounted relative to the body structure. This enables rotation and/or pivoting of the body structure relative to the support structure. The support structure therefore preferably comprises and opposing male/female engaging part at least permanently fixed to a support structure.

The body structure may comprise a cover portion provided forwardly and/or rearwardly of the opening, the cover portion partially providing a cover to the opening and the clamping element. The cover portion may be shaped to provide structural integrity to the body structure. The cover portion may be shaped to aid insertion and exiting of the flexible line from the upper and lower separation gaps respectively. The cover may have first and second apertures enabling access to the upper and lower separation gaps respectively.

Also according to the present invention there is a method of clamping a flexible line, the method comprising providing a clamping arrangement having a body structure having an upper end and a longitudinally spaced lower end and comprising an opening therein, the opening having a longitudinal length extending between an upper end and a lower end, and a clamping element arranged to co-operate with the body structure and extend across the opening, wherein an upper separation gap is defined between the upper end of the opening and the clamping element and a lower separation gap is defined between the lower end of the opening and the clamping element, the upper and lower separation gaps configured to allow a flexible line to extend through the upper and lower separation gaps concurrently, wherein the clamping element is moveable longitudinally relative to the body structure, the method comprising the steps of;
passing a distal end of a substantially de-tensioned flexible line through the upper separation gap and subsequently the lower separation gap;
tensioning the flexible line extending from the upper separation gap to provide a force downwardly on the clamping element clamping the flexible line between the clamping element and body structure.

Preferably the method is for hanging an object from a support structure wherein the distal end extends from an object and the weight of the object acts to force downwardly in the clamping element to hang the object at an above ground level.

The de-tensioned flexible line may extend from an object.

Preferably the method comprises the step of mounting the body structure to a support structure.

It will be appreciated that the body structure may be mounted to a support structure prior to passing the distal end of the flexible line through the upper and lower separation gaps however it is preferred that the body structure is mounted to a support structure after this step, and preferably after support is withdrawn from the object.

It will be appreciated that the clamping arrangement may be used to secure a flexible line. As such application of force to the distal end of the line increases tension in the line extending between a fixed location and the clamping arrangement.

The flexible line is preferably de-tensioned through positioning the object on a floor or other surface, and allowing the flexible line to be slack. Tension is preferably applied to the flexible line by lifting the support arrangement upwardly and subsequently lifting the object through upward movement of the support arrangement from the floor or support surface.

The step of tying a knot in the portion of flexible line projecting from the lower separation gap is preferably carried out. This step is preferably carried out immediately after passing the distal end of the flexible line through the upper and lower separation gaps.

The object is preferably a hay net.

The present invention will now be described by way of example only with reference to the accompanying drawings in which:

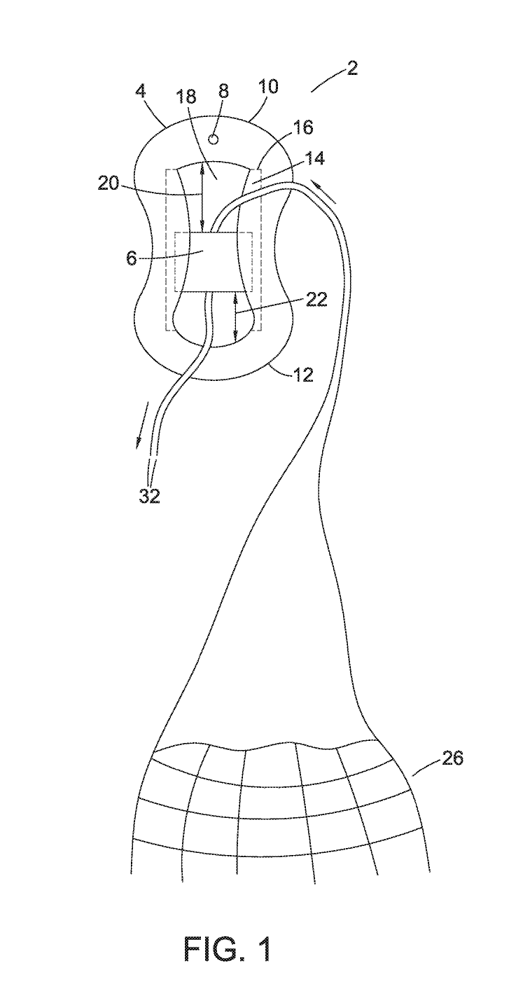

FIG. 1 is a schematic representation of an exemplary embodiment of the present invention.

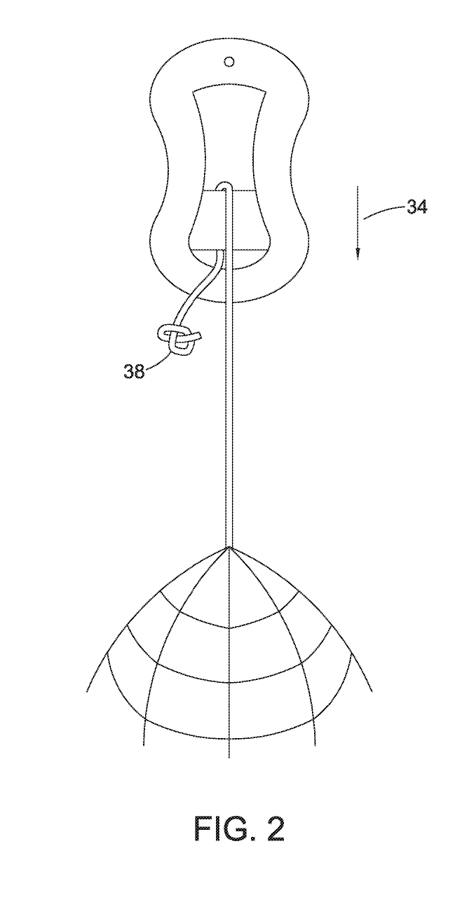

FIG. 2 is a schematic representation of an exemplary embodiment of the present invention in a clamped configuration.

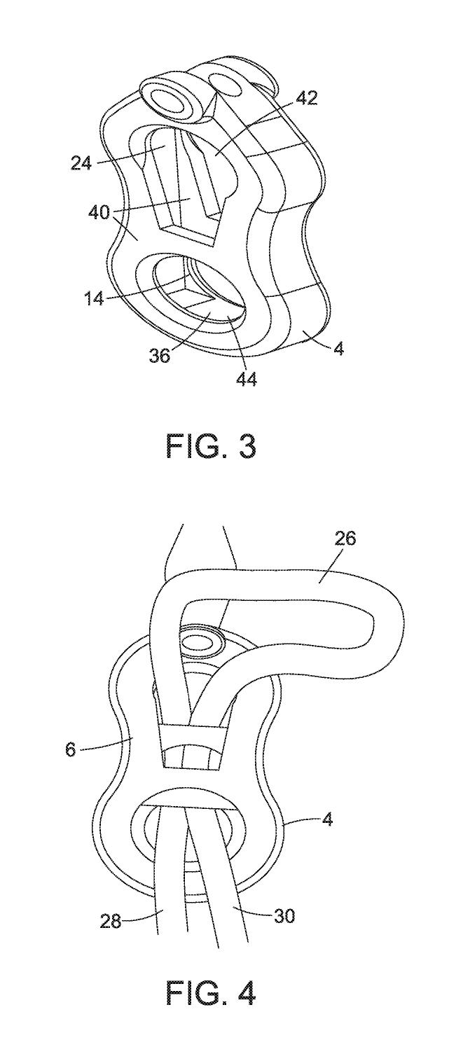

FIG. 3 is schematic perspective view of a body structure for use in an exemplary embodiment of the present invention.

FIG. 4 is a further perspective view of an exemplary embodiment of the present invention in a clamped configuration.

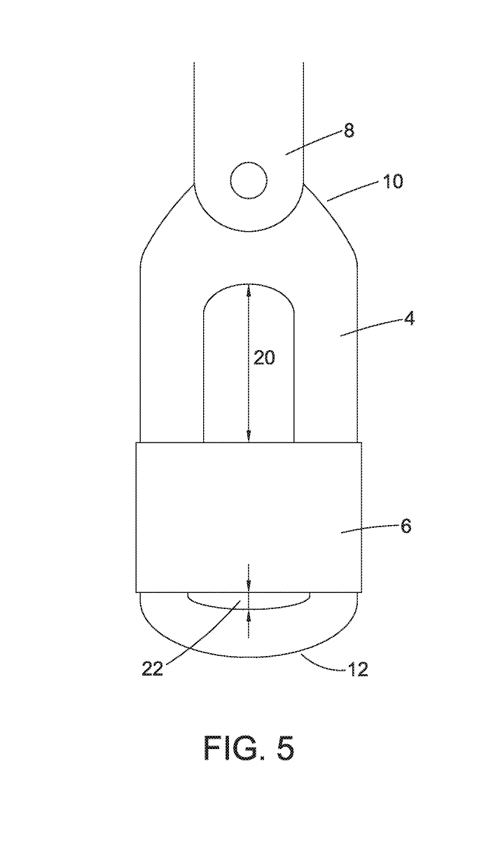

FIG. 5 is a schematic representation of an alternative exemplary embodiment of the present invention.

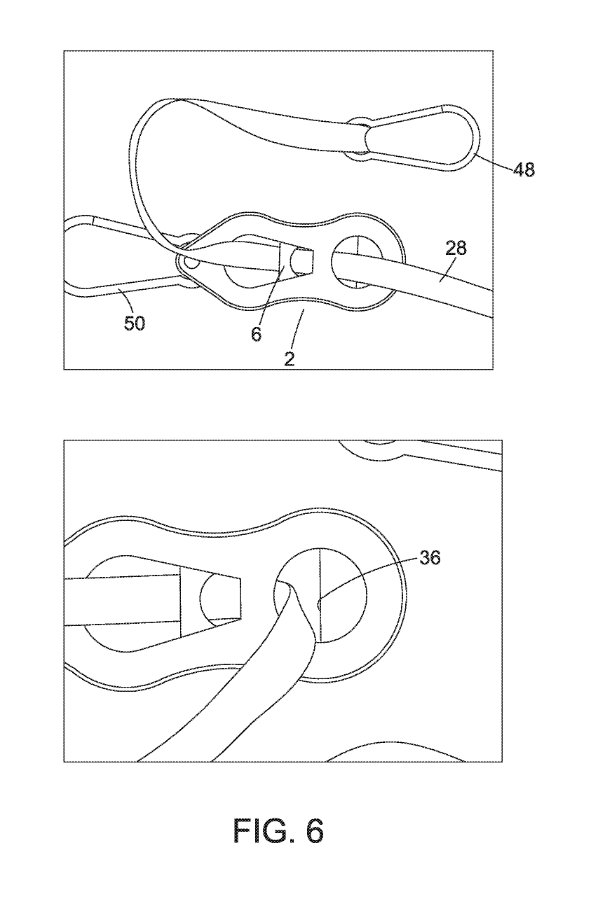

FIG. 6 is a schematic representation of an alternative exemplary embodiment of the present invention.

Referring to FIG. 1 there is a support arrangement (2) comprising a body structure (4) and a clamping element (6). The body structure (4) is arranged to be mounted to a support structure such as a ceiling or a wall and comprises a mounting formation (8) shown in the exemplary embodiment as an opening for receipt of a dowel which in turn may connect to a male or female engaging portion which in turn communicates with a corresponding male or female engaging portion secured to a wall or ceiling.

The body structure (4) is designed to cooperate with the clamping element (6) to enable movement longitudinally of the clamping element (6). The body structure (4) extends between an upper end (10) and a lower end (12). The clamping element (6) is retained by the body structure and is captive in the body structure. A chamber (14) is provided defined by the dashed lines (16) through which the clamping element (6) can move. The clamping element (6) extends across an opening (18) in the body structure (4) and an upper separation gap represented by arrow (20) and lower separation gap represented by arrow (22) are defined between the clamping element (6) and the upper and lower ends of the opening (18). As best represented in FIG. 3, the clamping element (6) has been removed for clarity and the chamber (14) can be clearly seen defined in the body structure (4). Opposing channels (24) are provided for receipt of the edges of the clamping element (6) to enable the clamping element (6) to slideably engage with the channels in the chamber (14).

As presented in FIG. 1, a hay net (26) is shown in an open configuration allowing the hay net to be filled. First and second elongate cords (28, 30) extend from the hay net in a de-tensioned or slack configuration and have been pushed through the upper separation gap (20) and subsequently drawn through the lower separation gap (22) and then extend to a distal end (32). This configuration is the unlocked configuration whereby there is minimal tension upon the cords (28, 30) and thus the upper end of the hay net (26) has not been drawn together nor has the clamping element (6) been activated.

Referring now to FIG. 2, upon lifting the support arrangement (2) tension is applied to the cords (28, 30) and thus the weight of the hay net (26) is taken from the support arrangement (2) and through the cords (28, 30). As the support arrangement (2) is lifted further the clamping element (6) is forced downwardly in a direction indicated by arrow (34). A further effect is that the upper edge of the hay net is drawn together and as the weight of the hay net (26) is transferred through the support arrangement (2) the clamping element (6) is forced downwardly and the cords (28, 30) are clamped between the clamping element (6) and the body structure (4). The clamping surface (36) of the body structure (4) can be clearly seen in FIG. 3. Thus, the support arrangement (2) can be lifted without slippage of the cords (28, 30) from the support arrangement (2). It will be appreciated that for security reasons that a knot (38) is tied into the distal ends (32) of the cords (28, 30).

Referring to FIG. 3, the body structure (4) is presented in more detail. It will be appreciated that the clamping element (6) is not shown in FIG. 3 for clarity purposes. The body structure (4) defines chamber (14) therein and the clamping element (6) when present does not project beyond the confines of the chamber (14). It will be appreciated, however, that the body portion (4) presented in FIGS. 3 and 4 particularly comprises front and rear cover portions (40). These cover portions are beneficial for providing structural integrity to the body structure (4) and improve strength. The opening (18) through which the clamping element (6) moves is uninterrupted by the provision of the cover portion (40). The cover portion (40) partially provides a cover to the opening (18) and the clamping element (6) and comprises first and second apertures (42, 44) to enable access to the upper and lower separation gaps (20, 22) respectively. The portion of the cover portions (40) adjacent to the first and second apertures (42, 44) may be profiled such as chamfered to aid insertion of the cords (28, 30) therethrough.

Referring to FIG. 4 the cords (28, 30) are presented having passed through the lower and upper separation gaps (22, 20) respectively and the ends of the cord are looped. This looped portion is represented by reference numeral (26) and tends in practice to the loop extending around the upper peripheral edge of the hay net. It will be appreciated that upon application of a downward force to the loop (26) the clamping element (6) is forced downwardly into tighter engagement with the cords (28), (30).

FIG. 5 is a further schematic exemplary embodiment of the present invention. In its embodiment the clamping element (6) is provided externally of the body structure (4) and slideably engages with respect to the body structure (4).

FIG. 6 is a further schematic exemplary embodiment of the present invention. In this embodiment a cord (28) in the form of a flat webbing. The clamping surface (36) in this embodiment is substantially linear in order to best secure such a type of webbing meaning that as the clamping element (6) pushes against the webbing (28) which is not twisted once clamped. It will be appreciated that in the embodiment presented clamping is achieved by supplying tension to the distal end of the cord (28) to which a clip (48) is secured. Thus, the clip (48) may be secured to a structure and the clip (50) may be secured to a load meaning that in effect the orientation of the support arrangement (2) is effectively reversed in operation.

It will be appreciated that the clamping arrangement is suitable for many applications. These include supporting a hay-net at an above-ground level, but also include tensioning a flexible line for many different purposes where one end of a flexible line may be fixed and passed through the clamping arrangement which is also then fixed or pre-fixed to a structure. Pulling the distal end of the flexible line causes tensioning in the flexible line and clamps the line holding the desired tension. In addition the flexible line itself may be elastically deformable such as a known bungee type cord.

Aspects of the present invention have been described by way of example only and it will be appreciated to the skilled addressee that modifications and variations may be made without departing from the scope of protection afforded by the appended claims.

1. A clamping arrangement for clamping a flexible line, the clamping arrangement comprising:
a body structure arranged to be mounted to a support structure and having an upper end and a longitudinally spaced lower end and comprising an opening therein, the opening having a longitudinal length extending between an upper end and a lower end;
a clamping element arranged to cooperate with the body structure and extend across the opening, wherein an upper separation gap is defined between the upper end of the opening and the clamping element and a lower separation gap is defined between the lower end of the opening and the clamping element, the upper and lower separation gaps configured to allow a flexible line to extend through the upper and lower separation gaps concurrently, wherein the clamping element is moveable longitudinally relative to the body structure such that tensioning a flexible line passed through the lower and upper separation gaps and projecting from the upper separation gap forces the clamping element downwardly to clamp the flexible line between the clamping element and the body structure.

2. A clamping arrangement according to claim 1 wherein the clamping element is slideably engaged with the body arrangement.

3. A clamping arrangement according to any preceding claim wherein the clamping element is captive in the body structure.

4. A clamping arrangement according to claim 3 wherein the clamping element is retained in the body structure.

5. A clamping arrangement according to any preceding claim wherein the body structure defines a chamber therein for receipt of the clamping element.

6. A clamping arrangement according to any of claims 3 to 5 wherein the body structure comprises opposing channels and wherein the clamping element comprises opposing edge portions received in the opposing respective channels.

7. A clamping arrangement according to any preceding claim wherein the longitudinal length of the body structure is less than 20 cm, and preferably less than 10 cm.

8. A clamping arrangement according to any preceding claim wherein the body structure comprises a mounting structure for releasably mounting to a support structure.

9. A clamping arrangement according to any of claims 3-8 wherein the body structure comprises a cover portion provided forwardly and/or rearwardly of the opening, the cover portion partially providing a cover to the opening and the clamping element.

10. A support arrangement according to claim 9 wherein the cover portion has first and second apertures enabling access to the upper and lower separation gaps respectively.

11. A method of clamping a flexible line, the method comprising providing a clamping arrangement having a body structure having an upper end and a longitudinally spaced lower end and comprising an opening therein, the opening having a longitudinal length extending between an upper end and a lower end, and a clamping element arranged to co-operate with the body structure and extend across the opening, wherein an upper separation gap is defined between the upper end of the opening and the clamping element and a lower separation gap is defined between the lower end of the opening and the clamping element, the upper and lower separation gaps configured to allow a flexible line to extend through the upper and lower separation gaps concurrently, wherein the clamping element is moveable longitudinally relative to the body structure, the method comprising the steps of;
passing a distal end of a substantially de-tensioned flexible line through the upper separation gap and subsequently the lower separation gap;
tensioning the flexible line extending from the upper separation gap to provide a force downwardly on the clamping element clamping the flexible line between the clamping element and body structure.

12. A method according to claim 11 comprising the step of tying a knot in the portion of flexible line projecting from the lower separation gap.

13. A method according to claim 11 for hanging an object from a support structure wherein the distal end extends from an object and the weight of the object acts to force downwardly in the clamping element to hang the object at an above ground level.

14. A method according to claim 13 comprising the step of mounting the body structure to a support structure.

15. A method according to any of claims 13-14 wherein the object is a hay net.
